(19) United States
(12) Patent Application Publication
(10) Pub. No.: US 2020/0215776 A1
(43) Pub. Date: Jul. 9, 2020

(54) METHODS AND SYSTEMS FOR CONVEYING OPTICAL FIBERS WITHIN A BRAIDED LAYER

(71) Applicant: Ziebel US Inc., Houston, TX (US)

(72) Inventors: John Grisham, Houston, TX (US); Neil Gardner, Houston, TX (US)

(21) Appl. No.: 16/735,190

(22) Filed: Jan. 6, 2020

Related U.S. Application Data
(60) Provisional application No. 62/788,512, filed on Jan. 4, 2019.

(51) Int. Cl. B29D 11/00; G02B 6/44

(52) U.S. Cl. CPC B29D 11/00663; B29K 2105/0061; G02B 6/4486

(57) ABSTRACT

Systems and methods for embedding fiber optics cables within woven fibers. More specifically, protecting fiber optic cables from fluids, well pressure, mechanical strain, and environmental hazards within a downhole setting, wherein the fiber optic cables are protected using braided fibers, gel, and metals.

### BACKGROUND INFORMATION

### Field of the Disclosure

Examples of the present disclosure relate to systems and methods for embedding optical fibers within composite carbon tubing. More specifically, embodiments are directed towards protecting fiber optic cables from fluids, well pressure, mechanical strain and environmental hazards within a downhole setting, wherein the fiber optic cables are protected using braided fibers, gel, and metals.

### Background

A variety of techniques have been utilized for monitoring reservoir conditions, estimating quantities of hydrocarbons in geological formations, determining wellbore parameters, determining conditions of downhole tools and geological formations, etc. One such technique includes embedding optical fibers within metal tubing. The optical fibers are then utilized to collect data within the well bore.

Conventional metal tubing with embedded optical fibers are formed by positioning the optical fibers onto a flat strip of metal, forming a tube from the flat strip of metal, and welding the resultant tube along a seam in a continuous process. However, this process is costly, and suffers from problems associated with creating pinholes in the welded seam. Specifically, resin can be injected into the metal tube during a pultrusion process. This potentially pre-strains the optical fibers, degrading the attenuation of the fiber optic cables or darkens the fiber, not allowing light to pass through the fiber. Also known as hydrogen darkening of fibers over time. Another drawback of the conventional metal tubing technique is when the metal tube breaks or is heavily damaged in a subsequent process, it is virtually impossible to repair the break and return the tube to full integrity and functionality while maintaining the outside diameter (OD) constant without an upset. The only remedy with these traditional metal tubes is to try and build two shorter than intended cables or carbon rods with the unbroken sections, or take a very costly write-off of the full length and start again.

Accordingly, needs exist for system and methods for embedding fiber optics within downhole tools, wherein the fiber optics are positioned within a braided tube, and that this braided tube be repairable to full integrity and functionality with a constant outside diameter, should a break or heavy damage occur during a subsequent process.

### SUMMARY

Examples of the present disclosure relate to systems and methods for embedding optical fibers within a composite braided tube, inside of which a braided filament yarn roving bundle includes the fibers and a gel. The braided tube may then be encompassed with a thermoplastic layer, which is impervious to gases. Embodiments may be configured to be more uniformly formed, while limiting resin from being sequenced into the optical fibers in a central cavity during the pultrusion process. This may limit the damage caused to the optical fibers when embedding the optical fibers within the braided tube. Embodiments may include optical fibers braided in a roving bundle, a braided fiber layer, gel, and a thermoplastic layer.

The fibers may be optical fibers, metal wires, of any other type of fiber that is configured to communicate data (referred to hereinafter individually and collectively as “optical fibers”). The optical fibers may be configured to transmit light between the ends of the fibers and may be immune to electromagnetic interference. Responsive to emitting the light, sensors may be configured to determine data based on light patterns.

The roving bundle may be a tube configured to house and protect the fibers. The roving bundle may be configured to encompass the fibers before the gel is inserted into the braided fiber layer and within the roving bundle. In embodiments, the roving bundle may be formed of glass, manufactured fiber made from natural sources such as wood and agricultural products that are regenerated as cellulose fiber, etc.

The braided fiber layer may be configured to encompass the optical fibers and the roving bundle. The braided fibers may be woven into a cylindrical tube with a hollow inner chamber. The optical fibers embedded within the roving bundle may be positioned within the hollow inner chamber. In embodiments, the braided layer may be formed of carbon fibers, glass fibers, etc. with a cured epoxy matrix. In embodiments, the braided fiber layer may be formed of a different material than the roving bundle.

The gel may be configured to fill the hollow inner chamber associated with the braided fibers as well as a hollow chamber within the roving bundle housing the optical fibers. In embodiments, the gel may be a thixotropic gel that is configured to protect the optical fibers and dampen the optical fibers to reduce noise. Additionally, the gel and optical fiber braided roving bundle may be configured to secure the optical fibers in place within the hollow chamber.

The thermoplastic layer may be a plastic material that is configured to be bonded to an exterior layer of the braided fiber layer. In embodiments, the thermoplastic layer may be impervious to gases, and may be configured to protect the braided fiber layer and the optical fibers positioned within the hollow chamber.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 depicts a tool, according to an embodiment,

FIG. 2 depicts a tool, according to an embodiment.

FIG. 3 depicts a system for forming a tool, according to an embodiment.

FIG. 4 depicts a system for forming a tool, according to an embodiment.

FIG. 5 depicts a system for forming a tool, according to an embodiment.

FIG. 6 depicts a method for forming a tool, according to an embodiment.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, numerous specific details are set forth in order to provide a thorough understanding of the present embodiments. It will be apparent, however, to one having ordinary skill in the art, that the specific detail need not be employed to practice the present embodiments. In other instances, well-known materials or methods have not been described in detail in order to avoid obscuring the present embodiments.

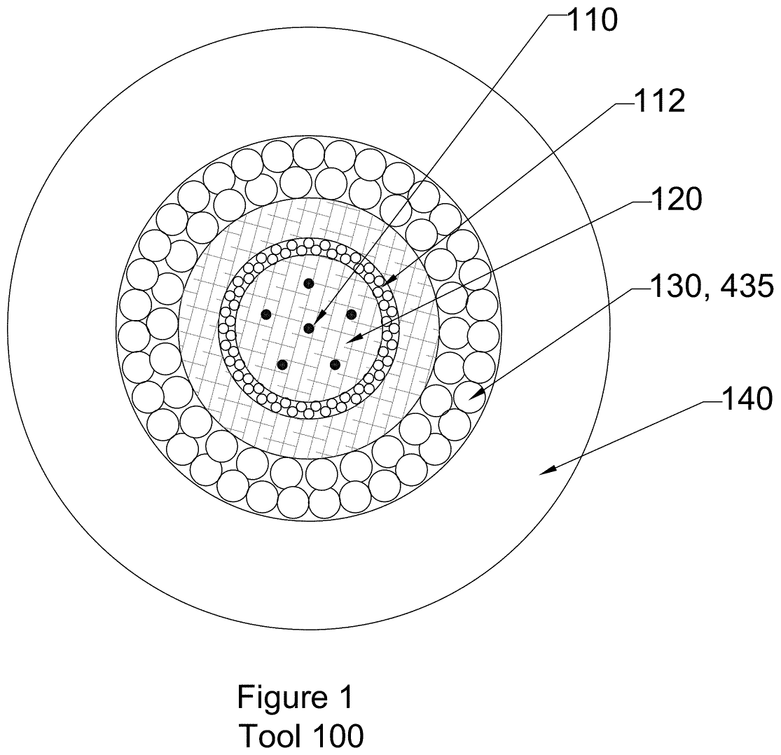

FIG. 1 depicts a tool 100 for conveying optical fibers 110 positioned within a braided roving bundle 112 within a braided layer 130, wherein the optical fibers 110 within braided roving bundle 112 may be positioned within the braided layer 130 in a continuous process. Tool 100 may include optical fibers 110, braided roving bundle 112, gel 120, braided layer 130, resin mix 435 and thermoplastic layer 140.

Optical fibers 110 may be any wired device that is configured to communicate data. Optical fibers 110 may be configured to transmit light between the ends of optical fibers 110, wherein first ends of optical fibers 110 may be positioned proximate to a surface of a wellbore, and second ends of optical fibers 110 may be positioned downhole. In embodiments, optical fibers 110 may be configured to operate as sensors, and determine data responsive to emitting light from the first ends of optical fibers 110 towards the second ends of optical fibers 110. Optical fibers 110 may be configured to relay signals to electronic devices that process the signals to measure acoustics, strain, temperature, pressure and other quantities by modifying a fiber so that the quantity to be measured modulates the intensity, phase, polarization, and optical fibers 110 may include electrical wires that are configured to transmit electrical signals between their first ends and second ends.

Roving bundle 112 may be a tube configured to house and encompass optical fibers 110. By encompassing optical fibers 110 within roving bundle 112, optical fibers 110 may be protected. In embodiments, roving bundle 112 may have a first inner diameter, and may be formed of glass, manufactured fiber made from natural sources such as wood and agricultural products that are regenerated as cellulose fiber, etc.

Gel 120 may be configured to be positioned around optical fibers 110 within roving bundle 112, and also in the space between roving bundle 112 and braided layer 130. By positioning gel 120 within braided roving bundle 112, gel 120 is able to protect optical fibers 110 from environmental hazards, and also reduce noise impacting optical fibers 110. In embodiments, gel 120 may be a thixotropic gel that is configured to fill up to eighty percent of the hollow chambers within the inner diameter of braided layer 130.

Braided layer 130 may be formed of braided fibers with a cured epoxy matrix 435 to form a composite tube with a second inner diameter, wherein the second inner diameter is greater than the first inner diameter. Optical fibers 110 in braided roving bundle 112 and gel 120 may be configured to be positioned within a hollow chamber within the inner diameter of braided layer 130. In embodiments, optical fibers 110 positioned within braided roving bundle 112 and gel 120 may be configured to be positioned within the hollow chamber while the composite tube is being formed. This may allow for system 100 to be formed in a separate but added continuous process.

Thermoplastic layer 140 may be a plastic material that is configured to be bonded to an exterior layer of the braided layer 130. Thermoplastic layer 140 may be impervious to gases, and may be configured to protect the braided layer 130 and the optical fibers 110 positioned within the hollow chamber.

By utilizing tool 100 optical fibers 110 may be protected within a plurality of layers and gel without utilizing steel. This may reduce manufacturing costs, as well as environmental noise when the optical fibers are eventually used to acquire downhole data in oil & gas wells.

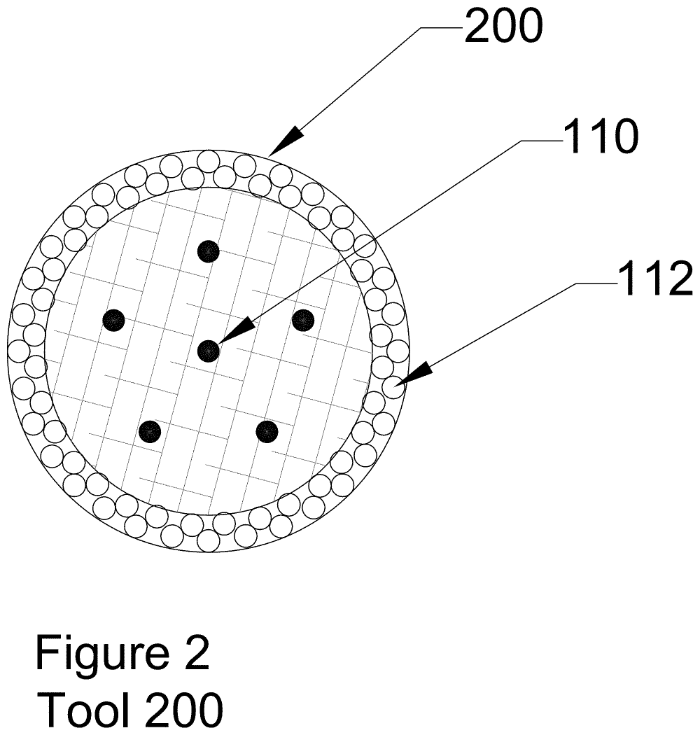

FIG. 2 depicts tool 200, which includes roving bundle 112 and optical fibers 110. Elements depicted in tool 200 may be described above, and for the sake of brevity a further description of these items is omitted.

As depicted in FIG. 2, a plurality of optical fibers 110 may be positioned within a roving bundle.

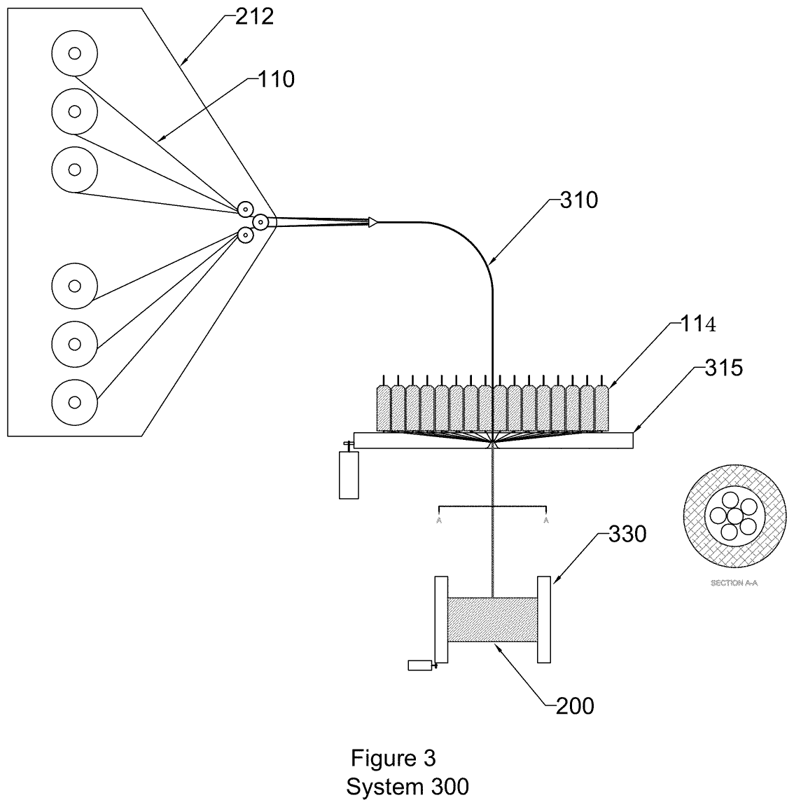

FIG. 3 depicts a system 300 to create tool 200, according to an embodiment. Elements depicted in system 300 may be described above, and for the sake of brevity a further description of these items is omitted. System 300 may be configured to embed optical fibers 110 in a braided roving bundle 112 in a continuous process. System 300 may include optical fiber spool Creel 212, capillary tube 310, braiding machine 315 with heat resistant yarn 114, and take up spool 330.

In embodiments, Optical fibers 110 may be fed by a plurality of optical fiber reels mounted on creel 212 and configured to supply the optical fibers 110 for system 200. The optical fibers 110 associated with optical fiber creel 212 may be fed through a flared end of a capillary tube 310 and fed into braiding machine 315.

As the optical fibers 110 are fed into a braiding machine, a roving bundle may be formed around the optical fibers via a braiding machine, wherein the outside layer of roving bundle 200 is formed of heat resistant yarn 114. This process may be a continuous process that allows a continuous reel of tool 200 to be dispensed to motorized take up spool 330.

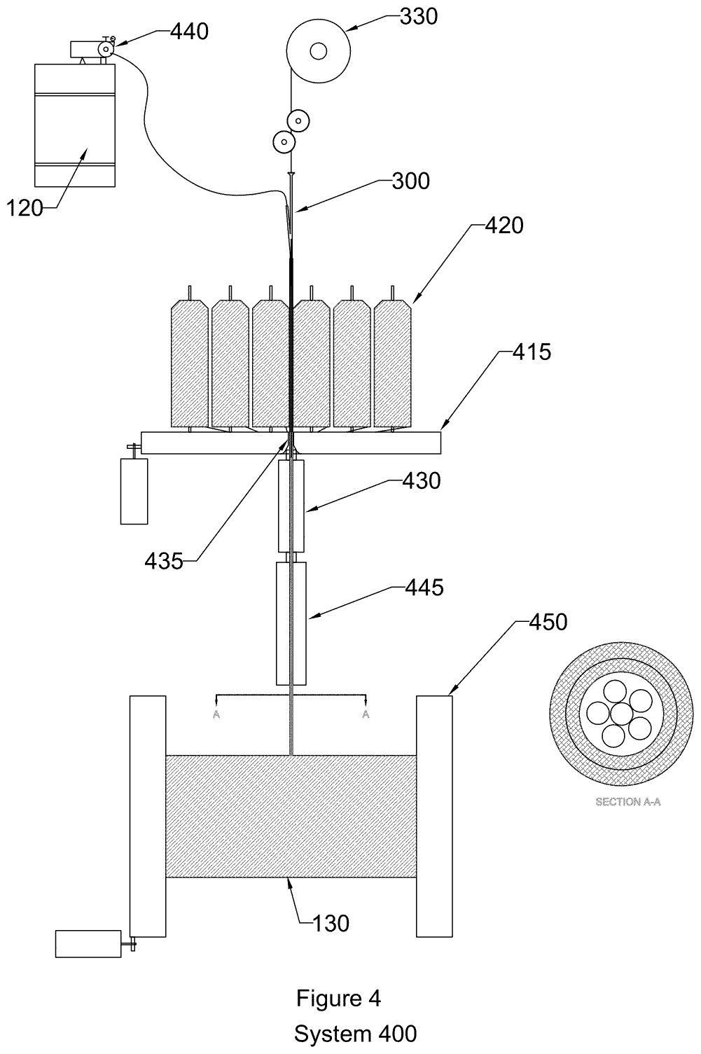

FIG. 4 depicts a system 400 configured to create tool 100. Elements depicted in FIG. 4 may be described above, and for the sake of brevity a further description of these elements is omitted. System 400 may include feeding spool 330, rotating frame 415, fiber bobbins 420, gel delivery pump 440, needle tube 300, process die 430, UV curing device 445 and finished reel 450.

The strands of optical fibers 110 positioned within braided roving bundle 112 supplied by feeding spool 330 may be configured to be positioned through a rotating frame 415 over a mandrel, wherein the mandrel receives carbon or glass fiber from fiber reels 420. Utilizing the mandrel, the fiber reels 420 may form the composite tube 130 over the mandrel, wherein this process may create large lengths of tool 200 embedded within composite tube 130 continuously. Epoxy resin 435 may then be positioned over the composite tube and cured 445 utilizing ultra violet light.

While the epoxy resin 435 is being positioned over the outer diameter of the composite tube 130 and being cured, needle 300 may be utilized to position gel 120 within the hollow chamber within the composite tube 130 and tool 200. This may result in a finished composite tube 130 within embedded gel and tool 200, which may be positioned on a take up, finished reel 450.

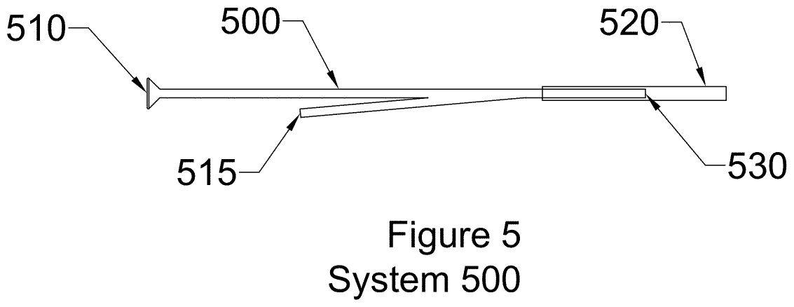

FIG. 5 depicts a detailed view of needle 500 utilized to position gel 120 within the hollow chamber of the braided layer 130 and tool 100, according to an embodiment. Elements depicted in needle 500 may be described above, and for the sake of brevity a further description of these items is omitted. In embodiments, needle 500 may be configured to position tool 200 through a first inlet 510 of needle 300. Gel 120 may be configured to be inserted into a second inlet 515, allowing for tool 200 to be filed with gel while braided layer 130 is being formed around tool 200. This may allow for a simultaneous and continuous process for filling tool 200 with gel while forming a secondary protection layer around tool 200.

Needle 500 may include a first inlet 510, second inlet 515, mandrel 520, and outlet 530.

First inlet may be an input port positioned on a proximal end of needle 500. First inlet 510 may be configured to position tool 200 within a hollow chamber within needle 500, such the tool 200 may be emitted from outlet 530.

Second inlet 515 may be a gel inlet 515, and may be an input port positioned between first input 510 and a proximal end of mandrel 520. Second inlet 515 may be configured to pump gel 120 within the hollow chamber within needle 500, wherein gel 120 may continuously dispensed within the hollow chamber within needle 500. Responsive to positioning gel 120 in the hollow chamber within needle 500, the gel 120 may interact with the optical fibers within hollow chamber within tool 200 and around optical fibers 110 while positioned within needle 500 to push the tool 200 towards output 530. In embodiments, second inlet 515 may be positioned at a tangential angle in relation to the central axis of needle 500. This may allow gel 120 positioned through second inlet 315 to push the tool 200 while not damaging the optical fibers 110 positioned within tool 200. Furthermore, this may enable gel 120 to interact with the tool 200 before being directly positioned in the hollow chamber within braided layer 130.

Mandrel 520 may be a hollow tube that is configured to shape braided layer 130, while gel 120 is being embedded within the hollow chamber tool 200 and within braided layer 130. Specifically, while gel 120 is filling the hollow chamber within tool 200 at a position proximate to second inlet 515, the gel 120 may simultaneously fill the hollow chamber associated with braided layer 130 at a position proximate to outlet 530.

In embodiments, a diameter of the braided layer 130 may be based on a diameter of mandrel 520. A proximal end of mandrel 520 may be configured to be positioned on a first side of outlet 530, and a distal end of mandrel 520 may be configured to be positioned on a second side of outlet 530.

Outlet 530 may be configured to emit tool 200 with embedded gel 120, while allowing gel 120 to be positioned within the hollow chamber associated with braided layer 130 encompassing tool 200. As such, tool 200 and gel 120 may be added while epoxy resin is added to an outer layer of the braided layer 120, which is cured via ultra violet light.

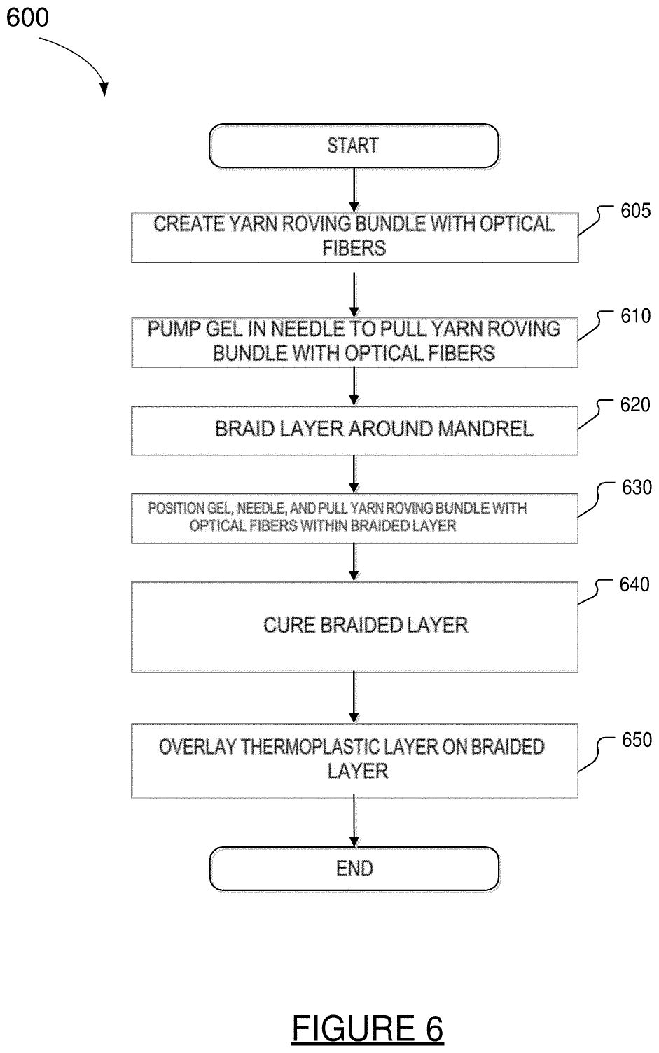

FIG. 6 depicts a method 600 to create a tool, according to an embodiment. The operations of method 600 presented below are intended to be illustrative. In some embodiments, method 600 may be accomplished with one or more additional operations not described, and/or without one or more of the operations discussed. Additionally, the order in which the operations of method 600 are illustrated in FIG. 6 and described below is not intended to be limiting.

At operation 605, a yarn roving bundle housing optical fibers positioned within an inner diameter of the yarn roving bundle may be created.

At operation 610, gel may be pumped through a gel inlet through at an angle into a needle.

At operation 620, a braided layer may be woven around a mandrel positioned around the needle, wherein a shape of the braided layer is based on a shape and size of the mandrel.

At operation 630, responsive to pumping the gel into the needle, the gel may interact with yarn roving bundle within the needle to pull the optical fibers through the needle. This may enable the gel to continuously pull tool 200 through the needle from a fiber inlet to an outlet of the needle, and into the hollow chamber within the braided layer as well as the yarn roving bundle.

At operation 640, while the gel is pulling the yarn roving bundle through the needle, the outer surface of the braided layer may be coated in epoxy resin and cured. This may cause the braided layer to harden.

At operation 650, a thermoplastic layer may be overlaid onto an outer surface of the braided layer.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A system for conveying optical fibers within tubing, the system comprising:
optical fibers configured to communicate data;
a braided yarn rovings configured to house the optical fibers, the braided yarn rovings including a first inner diameter;
a braided layer configured to encompass the braided yarn rovings, the braided layer including a second inner diameter;
a thermoplastic layer configured to encompass the braided layer, the thermoplastic layer having a third inner diameter;
gel configured to be embedded within the first inner diameter of the braided yarn rovings and the second inner diameter of the braided layer.

2. The system of claim 1, wherein the gel is configured to be simultaneously positioned within the braided yarn rovings and the braided layer.

3. The system of claim 2, wherein the optical fibers are configured to be positioned within the braided yarn rovings before positioning the braided yarn rovings within the braided layer.

4. The system of claim 1, further comprising:
a needle with a first input and a second input, wherein the braided yarn rovings housing the optical fibers is configured to be moved through the needle by the gel entering the second input.

5. The system of claim 4, wherein the gel is configured to be positioned within the first inner diameter when in the needle.

6. The system of claim 5, further comprising:
a mandrel encompassing an output of the needle, wherein the braided layer is configured to be braided around the mandrel while the gel is positioned within the first inner diameter.

7. The system of claim 6, wherein the gel is configured to be inserted into the second inner diameter as the braided layer is formed around the mandrel.

8. The system of claim 7, wherein the thermoplastic layer is configured to be overlaid on the braided layer after the gel is positioned within the first inner diameter and the second inner diameter.

9. The system of claim 1, wherein the braided layer is formed of fiberglass fibers, and cured into solid tubing by providing a ultraviolet cured epoxy matrix.

10. The system of claim 1, wherein the braided layer is formed of carbon fibers, and cured into solid tubing by providing a ultraviolet cured epoxy matrix.

11. A method for conveying optical fibers, the method comprising:
Positioning optical fibers within a braided yarn rovings, the braided yarn rovings including a first inner diameter;
Positioning the braided yarn rovings housing the optical fibers within a braided layer, the braided layer including a second inner diameter;
Positioning the braided layer along with the braided yarn rovings housing the optical fibers within a thermoplastic layer, the thermoplastic layer having a third inner diameter;
embedding gel within the first inner and the second inner diameter.

12. The method of claim 11, further comprising:
simultaneously positioning the gel within the braided yarn rovings and the braided layer.

13. The method of claim 12, further comprising:
positioning the optical fibers are configured to be positioned within the braided yarn rovings before positioning the braided yarn rovings within the braided layer.

14. The method of claim 11, further comprising:
moving the braided yarn rovings into first input of a needle;
flowing gel into a second input of the needle to move the braided yarn rovings housing the optical fibers through the needle.

15. The method of claim 14, further comprising:
positioning the gel within the first inner diameter when in the needle.

16. The method of claim 15, further comprising:
positioning a mandrel around an output of the needle;
braiding the braided layer around the mandrel while the gel is positioned within the first inner diameter.

17. The method of claim 16, further comprising:
inserting the gel into the second inner diameter as the braided layer is formed around the mandrel.

18. The method of claim 17, further comprising:
overlying the thermoplastic layer on the braided layer after the gel is positioned within the first inner diameter and the second inner diameter.

19. The method of claim 11, wherein the braided layer is formed of fiberglass fibers, and cured into solid tubing by providing a ultraviolet cured epoxy matrix.

20. The method of claim 11, wherein the braided layer is formed of carbon fibers, and cured into solid tubing by providing a ultraviolet cured epoxy matrix.
